(19) United States
(12) Patent Application Publication
(10) Pub. No.: US 2012/0331395 A2
(43) Pub. Date: Dec. 27, 2012

(54) Systems and Methods for Collaborative Interaction

(75) Inventors: Robert Kummerfeld, Dover Heights, AU (AU); Judy Kay, Dover Heights, AU (AU); James Bunton, Westleigh, AU (AU); Gregory Darke, Moorebank, AU (AU); Trent Apted, Kingsford, AU (AU)

(73) Assignee: Smart Internet Technology CRC Pty. Ltd., Eveleigh, AU (AU)

(21) Appl. No.: 12/993,687

(22) PCT Filed: May 19, 2009
(86) PCT No.: PCT/AU09/00622

§ 371 Date: May 19, 2011

(30) Foreign Application Priority Data
May 19, 2008 (AU) 2008902468

(51) Int. Cl. G06F 3/048

(52) U.S. Cl. 715/750

(57) ABSTRACT

A method for allowing multiple users to interact utilising a common user interface, the method comprising the steps of: for each user, receiving input data from said user and displaying said input in a user interface portion associated with the user, and, on receiving an instruction from the user, transferring the input data to a common interface portion viewable by the multiple users.

### FIELD OF THE INVENTION

The present invention relates to systems and methods for the collaboration and interaction of multiple users on an interactive computer interface, such as a tabletop interface.

### BACKGROUND OF THE INVENTION

Brainstorming sessions have become increasingly popular in many organisations, such as corporations and universities. A brainstorming session is where a group (plurality) of participants generate, collate and evaluate ideas, for any purpose (e.g. to decide how a new product will be marketed, to determine the content of a new university course, or to decide how a budget will be allocated).

A brainstorming session may conceptually be divided into two phases, namely “idea generation” and “idea selection”.

During the idea generation phase, participants in the brainstorming session are instructed to resist the temptation to evaluate ideas. The main goal of the idea generation phase is to produce a large quantity of ideas, where the wilder the idea, the better. Ideas should not be evaluated during this phase, but rather, should simply be recorded verbatim. Participants are also allowed (or encouraged) to add to ideas, or combine ideas, during the initial phase of idea generation.

Generally, ideas are “shouted out”, and a single appointed scribe (e.g. one of the participants), writes each idea on a large viewable surface, such as a whiteboard or a blackboard.

Once all ideas have been recorded, the brainstorming session moves to the idea selection phase. In the selection phase participants begin to evaluate and categorise the ideas which have been generated. Ideas may be discarded, grouped, or refined during this stage. Again, this is done in a largely manual fashion, with participants discussing each idea and then deciding to either discard, group or refine the idea. The appointed scribe then makes the necessary alterations to the ideas recorded on the whiteboard or the blackboard.

Production blocking is a problem which may arise during the idea generation phase. Since the appointed scribe can only note down one idea at a time other ideas being simultaneously vocalised must wait to be written down. A side effect arising from production blocking is that ideas can be lost or forgotten in the time taken to write them down.

Moreover, the manual collation of ideas is prone to error, is not easily transferred to an electronic format, and is generally inefficient.

### SUMMARY OF THE INVENTION

In a first aspect, the present invention provides a method for allowing multiple users to interact utilising a common user interface, the method comprising the steps of:

for each user, receiving input data from said user and displaying said input in a user interface portion associated with the user, and, on receiving an instruction from the user, transferring the input data to a common interface portion viewable by the multiple users.

In an embodiment the method comprises the further step of, on receiving input data from the multiple users, providing a collating function arranged to allow the multiple users to collate multiple instances of input data utilising an arbitrary collating mechanism.

In an embodiment at least one of the user interface portion and the common interface portion is a window arranged to display text.

In an embodiment the collating function is invoked when a user causes a window to be moved such that the window overlaps at least one other window.

In an embodiment the collating function is invoked when a user causes a closed shape to be drawn around a plurality of windows.

In an embodiment the collating function is invoked when a user causes a window to be placed within another window.

In an embodiment the arbitrary collating mechanism allows the user to ascribe at least one of metadata and additional data to each collation of input.

In an embodiment the method comprises the further step of displaying the input data in the common user interface in a manner which substantially de-identifies the origin of the data.

In an embodiment the method comprises the further step of detecting the presence of an additional input device, such that, when a new input device is connected to the computing system, a new user interface portion is provided for the user.

In an embodiment the collated instances of data may be saved to a file.

In an embodiment the step of moving the window comprises the user performing a dragging motion of the window by using at least one of a finger/stylus/mouse.

In an embodiment the first and common interface portions are located on a unitary interface.

In an embodiment the interface is a tabletop computing system interface.

In accordance with a second aspect of the present invention there is provided a system allowing multiple users to interact utilising a common user interface, comprising:

a module arranged to receive input data from said user and a display arranged to display said input in a user interface portion associated with the user, wherein, on receiving an instruction from the user, the input data is transferred to a common interface portion viewable by the multiple users.

In accordance with a third aspect of the present invention there is provided a computer program comprising at least one instruction which, when implemented on a computer readable medium of a computer system, causes the computer system to implement the method in accordance with the first aspect of the invention.

In accordance with a fourth aspect there is provided a computer readable medium providing a computer program in accordance with the third aspect of the invention.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic diagram of a system for implementing an embodiment of the present invention;

FIG. 2 is a flow chart showing method steps for a plurality of users collaborating via the collaborative tabletop interface provided by the system of FIG. 1, in accordance with an embodiment of the present invention;

FIG. 3 is a top view of the tabletop display showing unsorted pieces of virtual notepaper, in accordance with an embodiment of the present invention;

FIGS. 4, 5A and 5B are screen shots of the tabletop display illustrating a sorting process in accordance with an embodiment; and

FIG. 6 is a table outlining the results of a usability study comparing a prior art method against an embodiment of the present invention.

### DETAILED DESCRIPTION OF AN EMBODIMENT

### Introduction

In the description which follows an embodiment of the present invention is described in the context of a tabletop computing system and method for collaboratively generating, evaluating and categorising ideas. In particular, the system and method is well suited for the collection and categorisation of data (ideas) during a so-called “brainstorming session”.

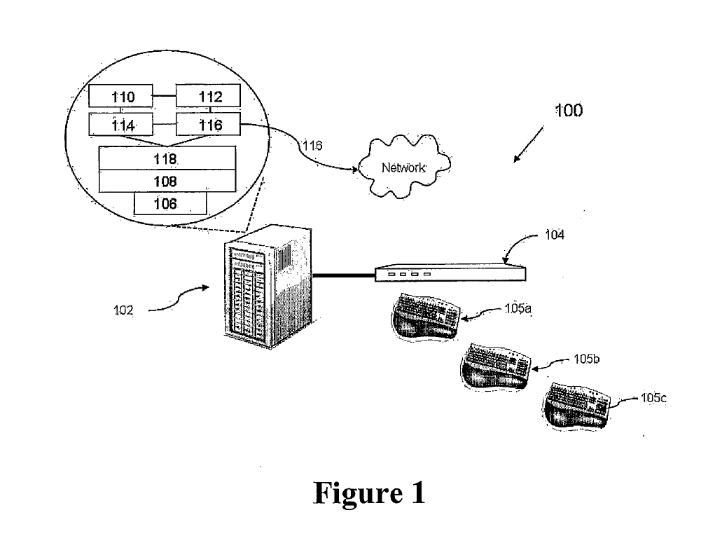

With reference to FIG. 1, there is shown a computing system in the form of a personal computer including a surface or “tabletop” touch-responsive screen display (hereafter “tabletop computer”). The tabletop computer comprises a single visual interface (i.e. the tabletop) but may be connected to multiple input devices, such as a keyboard, stylus (which allows a user to “write” on the interface), microphone or other suitable input device(s). In an embodiment, users can interact with the tabletop display using a combination of their hand and a stylus. In the following description, however, the term “stylus” will be understood to include either a user's hand or a physical stylus pen. In the embodiment described herein, the tabletop computer utilises multiple keyboards, which operate independently of each other and allow each participant to separately provide input into the computing system.

In the embodiment, the keyboards interface with a brainstorming application which operates in conjunction with a proprietary “Cruiser” framework designed specifically for a tabletop computing environment. The Cruiser framework includes at least one cruiser application operable to implement the basic functionality of the tabletop interface, such as the user interface, the standard commands utilised to manipulate objects displayed in the user interface, and co-operates with the operating system to perform low level functions, such as the creation and deletion of files, folders, etc. The Cruiser framework was originally developed by Smart Internet Technology Co-operative Research Centre Pty Ltd (a private Australian company), and aspects of the Cruiser framework are the subject of other Patent Applications AU2007904925 (subsequently filed as PCT Application No. PCT/AU2008/001342); AU2007904927 (subsequently filed as PCT Application No. PCT/AU2008/001345); AU2007904928 (subsequently filed as PCT Application No. PCT/AU2008/001343); AU2007904929 (subsequently filed as PCT Application No. PCT/AU2008/001344); and AU2007231829 (subsequently filed as U.S. application Ser. No. 12/264,031), which are herein incorporated by reference.

To execute the brainstorming application, the Cruiser application and the operating system, the tabletop computer 102 comprises computer hardware including a motherboard and central processing unit 110, random access memory 112, hard disk 114 and networking hardware 116. The tabletop touch-screen interface is denoted by the reference numeral 104. The operating system may be an operating system such as the Linux operating system, which can be obtained from the Internet at a website located at URL http://www.redhat.com (other versions of Linux are also available such as the SUSE distribution, available at URL http://www.suse.com). The operating system resides on the hard disk and co-operates with the hardware to provide an environment in which the software applications can be executed.

In this regard, the hard disk 114 of the tabletop computer 102 is loaded with the cruiser applications (which support the Cruiser framework) in addition to a brainstorming application. The tabletop computer 102 also includes a communications module including standard hardware and software (such as a TCP/IP) for receiving and sending files to one or more remote computers (not shown).

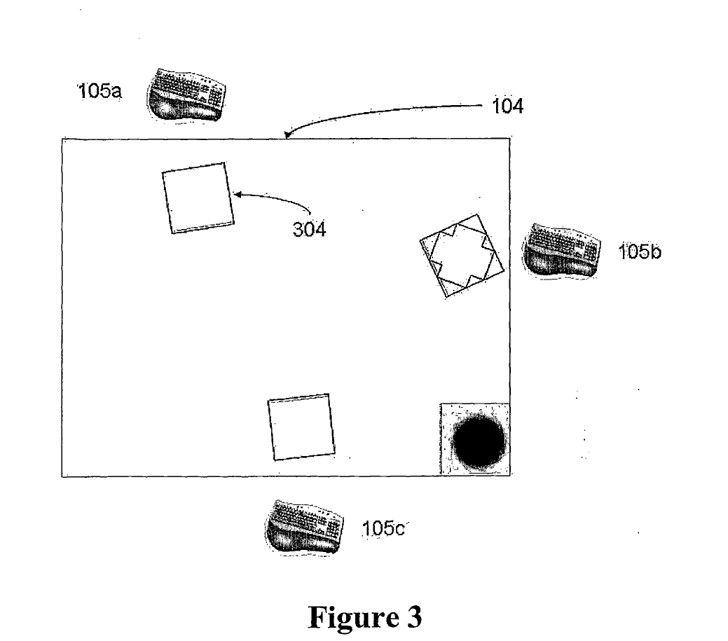

With additional reference to FIG. 1, when participants utilise the brainstorming application, they are each provided with an input device, such as a keyboard 105, and their immediate interface, as displayed in part of the tabletop computing user interface 104, consists of a virtual representation of a piece of notepaper (hereafter “virtual notepaper”). This is best shown in FIG. 3. The virtual notepaper 304 provides the user with a sense of familiarity, as they can conceptually understand that a piece of notepaper is to be utilised to record an idea. The virtual notepapers are arranged on the tabletop interface in a location proximate to the location of each keyboard, such that a user may understand which piece of notepaper corresponds to which keyboard. Of course, it will be understood that each piece of virtual notepaper may be easily moved to a more convenient location by use of the stylus, which functions to “drag”, “mark” or otherwise interact with objects on the tabletop interface.

It will be understood that the system may also utilise a “hybrid” input system, where participants are provided with “tablet” personal computers (PCs), which are remotely or wirelessly connected to the tabletop interface. Participants can interact with the tablet PC in much the same manner as previously described herein. However, where tablet PCs are utilised as an input device, the virtual notepaper may appear on the tablet PC at first instance, rather than on a user interface portion on the tabletop. Such variations are within the purview of a person skilled in the art.

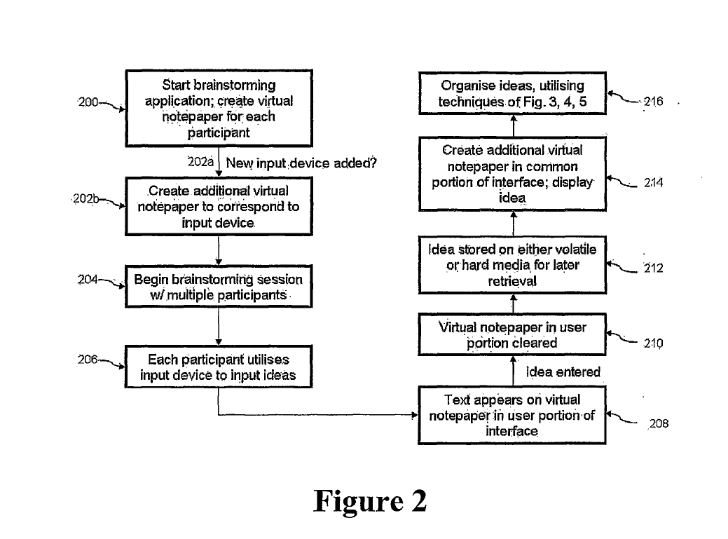

The manner in which participants (users) interact with the embodiment is now described with reference to the flow chart at FIG. 2.

When a brainstorming session is begun 200, virtual notepaper is created for each participant and the idea generation phase is entered. In the embodiment described herein, the brainstorming application is also arranged to sense when an additional keyboard has been added to the tabletop interface 202a. For each additional keyboard that is added, an additional piece of notepaper appears on the tabletop interface 202b. As such, participants can be added to the brainstorming session at any time. The sensing may be achieved in any suitable manner. For example, where a USB (Universal Serial Bus) interface is utilised to connect keyboards, the brainstorming application may periodically poll the cruiser applications or operating system to determine whether a new keyboard has been added. The location of the new keyboard may then be “guessed”, by, for example, determining which USB port was used to connect the keyboard. In a situation where each USB port is prior mapped to a particular section of the tabletop interface, a window (virtual piece of notepaper) may then be displayed in the appropriate section of the tabletop interface, and mapped to the connected keyboard. In respect of the “hybrid” input system (i.e. where wireless input devices are also connected), the proximity of a wirelessly connected device (e.g. tablet PC) can be determined by scanning for the presence of known devices using short-range radio such as Bluetooth™. When the wireless device is considered to be in communicable range, a wireless connection is made between the device and the tabletop computer 102. Once all participants are entered, the brainstorming session begins 204.

Each participant that is part of the brainstorming session utilises their respective keyboard to type text 206. The text they have typed appears in real time on their virtual piece of notepaper 208. Editing features such as backspace, wordwrap and line breaks are supported by the brainstorming application, to assist the participant in writing clearly and legibly. Of course, it will be understood that the participant may, in other embodiments, utilise different input devices, such as the stylus to handwrite ideas, a microphone to voice ideas (which can then be converted into text utilising appropriate voice recognition software) or provide their input by way of a remotely connected device, such as a wireless tablet personal computer, or the like. Such variations are within the purview of a person skilled in the art.

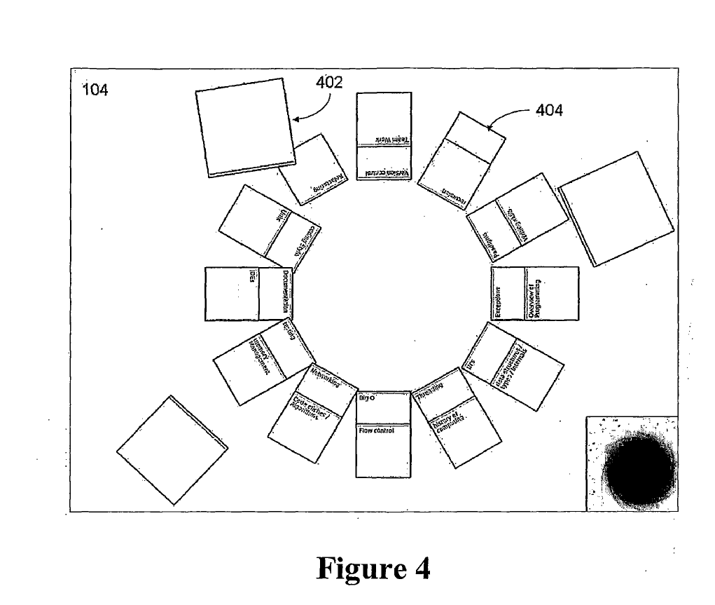

When a participant has finished entering an idea, they press CTRL-Enter (or utilise another suitable key combination or command) to store the idea. Once the participant decides to store the idea, a number of functions are performed by the brainstorming application. Firstly, the participant's virtual piece of notepaper is cleared 210, so that the participant may enter further ideas. Secondly, their idea is stored (either in RAM or on a secondary storage device 212), so that it may be retrieved at a later time. Thirdly, a new virtual piece of notepaper is created in an area of the tabletop interface common to all users (i.e. an area akin to the real life whiteboard) which includes the previously stored idea(s) 214. That is, the idea is displayed in a “pool” of ideas in a common area which is clearly visible to other participants. In the embodiment described herein, the common area is generally a central portion of the tabletop interface. The ideas may be displayed in a “circular” fashion, spiral layout or indeed any other appropriate layout (e.g. grouped in columns, etc) that allows each participant to see multiple ideas. An example screen shot illustrating the organisation of captured ideas in a spiral layout is shown in FIG. 4. In FIG. 4, cleared or new pieces of notepaper are denoted by the reference numeral 402, whereas stored ideas are denoted by the reference numeral 404.

It will be understood by persons skilled in the art that the actual layout may be pre-defined by the brainstorming application or alternatively may be specified by one or more of the participants. Further, the introduction of the ideas 404 into the common area may be a noticeable movement which can be detected in the users' peripheral view to improve their awareness that a new idea has been added. This noticeable movement may also provide some feedback to the user who added the idea. Moreover, the ideas 404 may be collated and displayed as they are entered by each participant, such that there is no explicit link between the origin of the idea and the position or location of the virtual piece of notepaper. This provides a level of anonymity, which goes some way to participants being able to objectively assess ideas.

Moreover, as multiple participants can simultaneously enter text by using their respective keyboards they do not need to rely on a central scribe to record their ideas. As such, the production blocking problem which occurs in the idea generation phase of conventional brainstorming techniques is largely alleviated.

Returning briefly to FIG. 2, after the participants have entered all of their ideas, the idea selection phase can be initiated, whereby participants can begin to organise their ideas 216.

Organisation can be facilitated by using styli which effectively act as “pointers” and may be used to move around the virtual pieces of notepaper on the tabletop surface. Ideas may then be grouped in a number of ways.

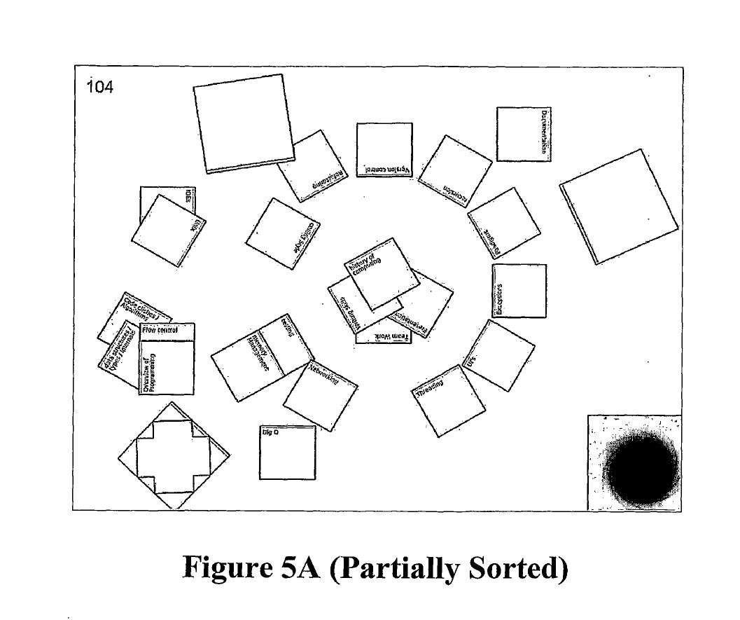

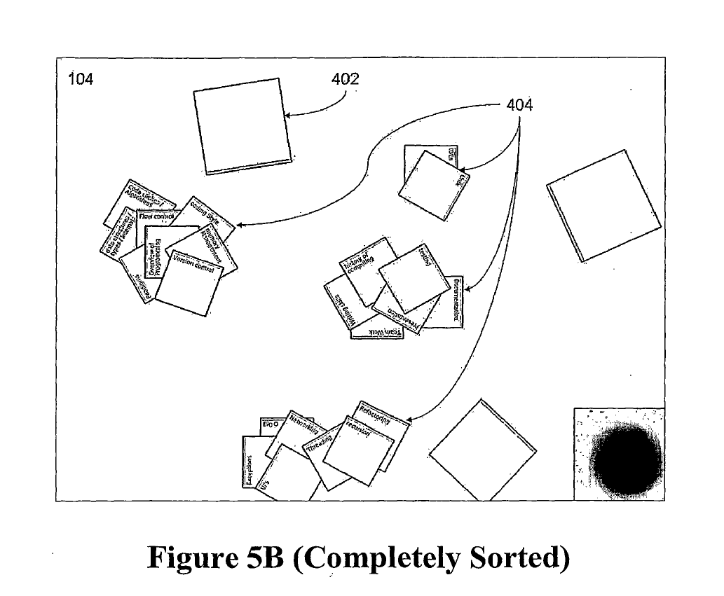

In a first method, and with specific reference to FIGS. 5A and 5B, the virtual pieces of notepaper may be moved by one or more participants such that they “overlap” or “stack”. The tabletop then utilises an algorithm to group overlapped or stacked ideas into a category. According to the embodiment described herein, the algorithm checks for collisions between two-dimensional rectangles (displayed on the interface) to determine whether virtual notepaper objects are overlapping or touching. All determined overlapping objects may, for example, be deemed by the brainstorming application to be part of the same group of ideas, or relate to the same topic.

In a second method, a user may draw a virtual “circle” (or other enclosed shape) around a group of virtual pieces of paper. Again, the tabletop utilises an algorithm to group ideas which are within a common circle (or other enclosed shape). In one example implementation, computer program code implemented by the brainstorming application sees each piece of notepaper as a single point on the screen (e.g. the point could be at the centre of the notepaper). The code can then determine if the point (i.e. notepaper) is lying within the common circle bounds (represented as a polygon) by drawing an imaginary line from the single point to a point that is an indefinite distance away. The number of times the line intersects the polygon is counted. If the line crosses an odd number of times then the brainstorming application understands the notepaper as being inside the polygon (and thus part of the defined group).

In a third method, a user may move a virtual piece of notepaper “into” another virtual piece of notepaper. This creates a natural grouping of ideas within a virtual piece of notepaper. That is, a virtual piece of notepaper can act as both a file (i.e. it can hold text), and as a folder (it can also hold other virtual pieces of notepaper). The virtual piece of notepaper may also be capable of holding metadata, such that the virtual piece of notepaper may include a title, a creation date and time, a relative importance ranking (e.g. some ideas may be tagged or marked as “very important”, while others may be marked as being of “marginal importance”) or any other information that may be useful to the brainstorming session.

Of course, virtual pieces of notepaper may also be deleted, where there is redundancy or where an idea is determined not to be suitable.

The ideas may be collated or collected according to an arbitrary hierarchy or organisation principle which is decided by the participants as they are collating the ideas. Participants are provided with a number of ways in which to organise, discard, prioritise and/or label/tag ideas, as required by their own organisational requirements.

Once all ideas are collated and refined to the satisfaction of all participants, the virtual pieces of notepaper may easily be exported to a text file (or other format), for electronic dissemination or for printing. Where the participants have indicated that the ideas are to be categorised according to some arbitrary hierarchy, this hierarchy may be included as data or meta-data, such that the electronic file or the printed copy lists the ideas in the order indicated by the arbitrary hierarchy. Similarly, where ideas have been labelled or tagged, the label or tag may be provided as meta-data or as data to appropriately rank or otherwise categorise the ideas.

Listing of Software Components

In the embodiment described herein, the brainstorming application is composed of a number of disparate software components, libraries and modules, which interact with each other to provide the functionality described above. It will be understood that the components, libraries and modules described herein are illustrative of one embodiment only, and that other software applications may use different architectures, modules, components or libraries without departing from the broader invention disclosed and claimed herein.

1. Keyboardlib library: A reusable Linux C library for receiving keyboard events from all the distinct keyboards connected to a computer. It supports hot/cold plugging of input devices; includes support for different keyboard layouts, etc.

2. Brainstorm plugin: Runs on a tabletop interface module of the brainstorming application and interfaces with the keyboardlib library to provide an interface for multiple simultaneous inputs to the tabletop system. The tabletop interface module provides the visual functionality, including resizing, moving, deletion and organisation.

Usability Testing

An exploratory study was conducted to gain qualitative data on the way people used the brainstorming application compared to a more tradition whiteboard approach for brainstorming. The study utilised a double crossover method in which a traditional brainstorming session was compared to the use of the brainstorming application. The order in which the interfaces were used was varied in order to minimize the effect of people learning the Brainstorm application/table top interface.

During the study two brainstorming topics were provided to participants. The first topic related to a first year programming course, and the second related to a UNIX course. The order of the questions was kept fixed during the trials.

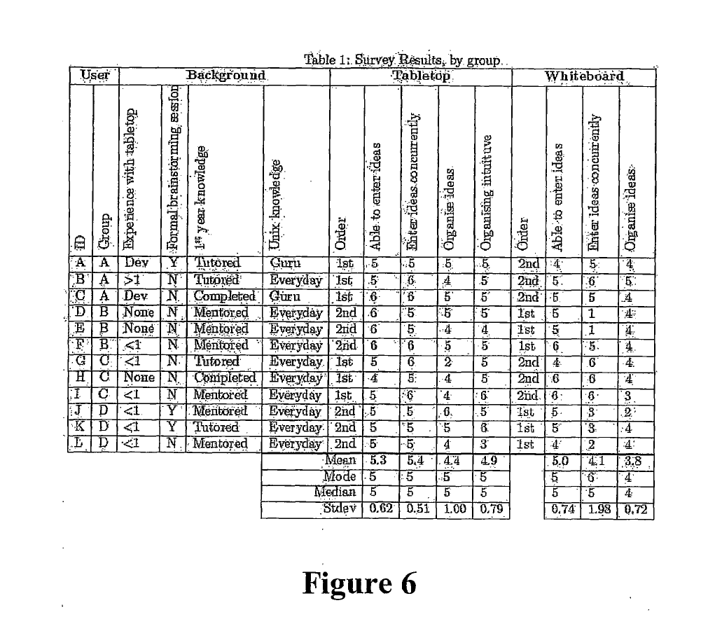

Participants were asked to fill out three short surveys. An initial survey to determine the user's background knowledge (on the tabletop, brainstorming in general, and the two discussion topics), then a separate survey after using each interface. The results are summarised in Table 1 (shown as part of FIG. 6), and also described in some detail below. It is noted that the answers provided by the participants in the study were indications of agreements with statements on a six-point “likert” scale.

Participants were given twenty minutes to complete each brainstorming session (ten minutes to come up with the ideas and another ten minutes to collate and discard the ideas). The participants were also given 10-15 minutes to interact with a tabletop tutorial and also to generally interact with the system, so that they could familiarise themselves with the system prior to carrying out the study.

A total of 12 people participated in the study, and they were split into four groups each containing three members. These groups have been labelled with the letters A-D.

All participants had knowledge about the two discussion topics, as can be seen from the table. The participants were sourced from the School of IT building at the University of Sydney, Australia.

From the table provided at FIG. 6 it can be seen that Group A stands out having two participants who both were part of the tabletop development. This group also had a higher level of background knowledge of the two brainstorming topics, with two people who have tutored the course, and two people who consider their knowledge of Unix to be at the “Guru” level (a very high level).

The participants in all other groups had little to no experience with using the tabletop interface.

After an analysis of the results for the participants' surveys, it was determined that only two users found it easier to enter ideas on the whiteboard. The participant's attributed this opinion to both the keyboard used during the study (the participants in question found that the provided keyboard was hard to use) and that the font size was too large (they could not get enough information into the virtual notepapers). The users who found the tabletop easier to enter ideas on mainly attributed the ease of use to ease with which an idea may be typed rather than the need to have their idea “heard” and then written on a whiteboard. All participants, bar one, rated their ability to enter ideas as 5 or greater (which is representative of the second highest possible score; with “1” being the lowest).

Only one participant indicated that they found it easier to concurrently enter ideas onto the whiteboard, and even though they rated the whiteboard higher, they still gave the tabletop a score of 5 out of 6. The scores given to the tabletop by participants were all either 5 or 6, the scores they gave the whiteboard had a much larger variability (stdev=1.98).

Seven of the twelve participants found that it was easier to organise their ideas on the tabletop rather than the whiteboard, with all participants (except one) giving tabletop a score of 4 or higher. The two users who scored the whiteboard higher than the table attributed these scores to the system being slow (a re-draw “bug” which has since been fixed), that only one person can ‘touch’ the table at a time (resulting from a limitation of the hardware used in the particular hardware setup for the study, although it is noted that in other system setups multiple users can touch and manipulate objects on the screen simultaneously) and that they had trouble seeing what was already in a pile.

All participants (except one) found the concept of organising their ideas into “piles” intuitive (gave a rating of 4 or above).

From the results it can be seen that most users, despite only having a small amount of time to familiarise themselves with the tabletop brainstorming application, preferred the brainstorming application to a traditional brainstorming method utilising a whiteboard.

Moreover, in addition to ease of use, the embodiment described herein largely alleviates production blocking, is less prone to error (as each user has complete control over the ideas they create in the idea creation phase), and allows the output to be collated, refined and reproduced in a very efficient manner.

In the preceding embodiments, reference has been made to a software application. It will be understood that the software application may be written in any appropriate computer language, and arranged to execute on any suitable computing hardware, in any configuration. The software application may be a stand-alone software application arranged to operate on a personal or server computer, or a portable device such as laptop computer, or a wireless device, such as a tablet PC or a PDA (personal digital assistant).

The software application may alternatively be an application arranged to operate on a central server or servers. The application may be accessed from any suitable remote terminal, through a public or private network, such as the Internet.

Where the software application interfaces with another computing system or a database, the data may be communicated via any suitable communication network, including the Internet, a proprietary network (e.g. a private connection between different offices of an organisation), a wireless network, such as an 802.11 standard network, or a telecommunications network (including but not limited to a telephone line, a GSM, CDMA, EDGE or 3G mobile telecommunications network, or a microwave link).

It will also be understood that the embodiments described may be implemented via or as an application programming interface (API), for use by a developer, or may be implemented as code within another software application. Generally, as software applications include routines, programs, objects, components, and data files that perform or assist in the performance of particular functions, it will be understood that a software application may be distributed across a number of routines, objects and components, but achieve the same functionality as the embodiment and the broader invention claimed herein. Such variations and modifications would be within the purview of those skilled in the art.

The foregoing description of the exemplary embodiments is provided to enable any person skilled in the art to make or use the present invention. While the invention has been described with respect to particular illustrated embodiments, various modifications to these embodiments will be readily apparent to those skilled in the art, and the generic principles defined herein may be applied to other embodiments without departing from the spirit or scope of the invention.

The present embodiments are, therefore, to be considered in all respects as illustrative and not restrictive.

A reference herein to a prior art document is not an admission that the document forms part of the common general knowledge in the art in Australia.

1. A method for allowing multiple users to interact utilising a common user interface, the method comprising the steps of:
for each user, receiving input data from said user and displaying said input in a user interface portion associated with the user, and, on receiving an instruction from the user, transferring the input data to a common interface portion viewable by the multiple users.

2. A method in accordance with claim 1, comprising the further step of, on receiving input data from the multiple users, providing a collating function arranged to allow the multiple users to collate multiple instances of input data utilising an arbitrary collating mechanism.

3. A method in accordance with claim 1, wherein at least one of the user interface portion and the common interface portion is a window arranged to display text.

4. A method in accordance with claim 3 when dependent on claim 2, wherein the collating function is invoked when a user causes a window to be moved such that the window overlaps at least one other window.

5. A method in accordance with claim 3 when dependent on claim 2, wherein the collating function is invoked when a user causes a closed shape to be drawn around a plurality of windows.

6. A method in accordance with claim 3 when dependent on claim 2, wherein the collating function is invoked when a user causes a window to be placed within another window.

7. A method in accordance with claim 2, wherein the arbitrary collating mechanism allows the user to ascribe at least one of metadata and additional data to each collation of input.

8. A method in accordance with claim 1, comprising the further step of displaying the input data in the common user interface in a manner which substantially de-identifies the origin of the data.

9. A method in accordance with claim 1, comprising the further step of detecting the presence of an additional input device, such that, when a new input device is connected to the computing system, a new user interface portion is provided for the user.

10. A method in accordance with claim 2, wherein the collated instances of data may be saved to a file.

11. A method in accordance with claim 3, whereby the step of moving the window comprises the user performing a dragging motion of the window by using at least one of a finger/stylus/mouse.

12. A method in accordance with claim 1, wherein the first and common interface portions are located on a unitary interface.

13. A method in accordance with claim 1, wherein the interface is a tabletop computing system interface.

14. A system allowing multiple users to interact utilising a common user interface, comprising:
a module arranged to receive input data from said user and a display arranged to display said input in a user interface portion associated with the user, wherein, on receiving an instruction from the user, the input data is transferred to a common interface portion viewable by the multiple users.

15. A system in accordance with claim 14, comprising the further step of, on receiving input data from the multiple users, providing a collating function arranged to allow the multiple users to collate multiple instances of input data utilising an arbitrary collating mechanism.

16. A system in accordance with claim 14, wherein at least one of the user interface portion and the common interface portion is a window arranged to display text.

17. A system in accordance with claim 16 when dependent on claim 15, wherein the collating function is invoked when a user causes a window to be moved such that the window overlaps at least one other window.

18. A system in accordance with claim 16 when dependent on claim 15, wherein the collating function is invoked when a user causes a closed shape to be drawn around a plurality of windows.

19. A system in accordance with claim 16 when dependent on claim 15, wherein the collating function is invoked when a user causes a window to be placed within another window.

20. A system in accordance with claim 14, wherein the arbitrary collating mechanism allows the user to ascribe at least one of metadata and additional data to each collation of input.

21. A system in accordance with claim 14, comprising the further step of displaying the input data in the common user interface in a manner which substantially de-identifies the origin of the data.

22. A system in accordance with claim 14, comprising the further step of detecting the presence of an additional input device, such that, when a new input device is connected to the computing system, a new user interface portion is provided for the user.

23. A system in accordance with claim 15, wherein the collated instances of data may be saved to a file.

24. A system in accordance with claim 16, whereby the step of moving the window comprises the user performing a dragging motion of the window by using at least one of a finger/stylus/mouse.

25. A system in accordance with claim 14, wherein the first and common interface portions are located on a unitary interface.

26. A system in accordance with claim 14, wherein the interface is a tabletop computing system interface.

27. A computer program comprising at least one instruction which, when implemented on a computer readable medium of a computer system, causes the computer system to implement the method in accordance with claim 1.

28. A computer readable medium providing a computer program in accordance with claim 27.
